(19) United States
(12) Patent Application Publication
(10) Pub. No.: US 2006/0125965 A1
(43) Pub. Date: Jun. 15, 2006

(54) Method and device for separating a chrominance signal from a composite video baseband signal

(76) Inventor: Jean-Jacques Richard Michel Vandenbussche, Brugge (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,981

(22) PCT Filed: Dec. 5, 2003
(86) PCT No.: PCT/IB03/05829

§ 371 Date: Jul. 11, 2005

(30) Foreign Application Priority Data
Jan. 14, 2003 (EP) 03100050.8

(51) Int. Cl. H04N 9/77

(52) U.S. Cl. 348/663

(57) ABSTRACT

The invention relates to a method for separating a chrominance signal from a composite video baseband signal. In order to improve the separation, it is proposed that the composite video baseband signal is filtered sequentially in any order by means of spatial comb filter means in horizontal and vertical direction and by means of field comb filter means in vertical direction and temporally to obtain said chrominance signal. Thereby, the advantages of a spatial and a temporal filtering at different vertical frequencies can be combined. The invention relates equally to a chrominance-luminance separator comprising filter means for realizing the proposed method.

The invention relates to a method and to a chrominance-luminance separator for separating a chrominance signal from a composite video baseband signal.

It is known from the state of the art to transmit chrominance and luminance information for moving color pictures in form of a composite video baseband signal. Frequency interleaved chrominance and a luminance signals forming such a composite video baseband signal are defined for example in PAL (phase-alternation line) or NTSC (National Standard Systems Committee) standards for color television systems.

A receiver has to comprise filter means for separating the luminance and the chrominance signal in the composite video baseband signal in order to be able to reconstruct and display the original pictures.

For separating the chrominance signal from a composite video baseband signal, conventional TV sets comprise for example an ordinary 2D spatial comb filter, which filters received composite video baseband signal in a vertical and a horizontal dimension. A spatial comb filter comprises to this end a non-recursive high pass performing a filtering over two or four lines, the output of the high pass being supplied via a bandpass as chrominance signal. Such a spatial comb filter is described for instance by Christian Hentschel in “Video Signalverarbeitung”, ISBN 3-519-06250-X, pp. 96-119. A spatial comb filter has the advantage over a simple bandpass and notch filter combination that it enables a better adaptation of the filter characteristics to the signal characteristics and thus a more efficient separation of luminance and chrominance signals for certain image contents.

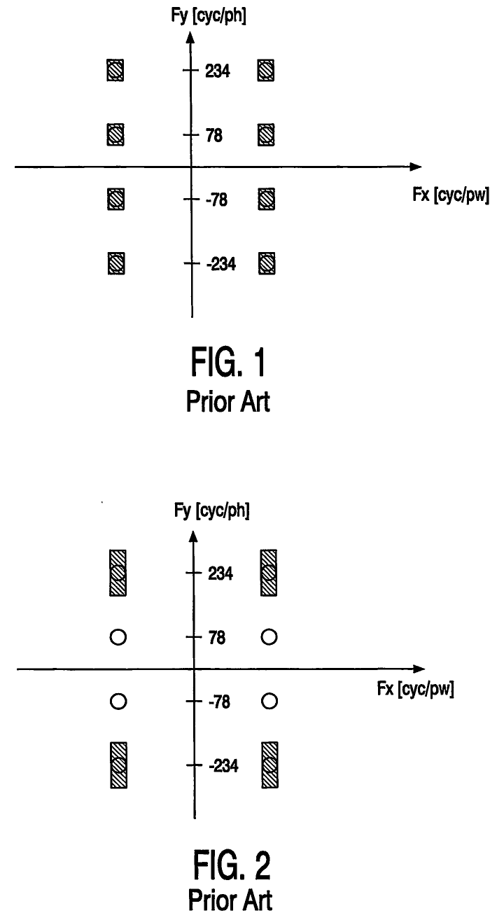

FIG. 1 is a diagram depicting the chroma bandpass area of a spatial comb filter for PAL in the Fx/Fy plane for pictures having a time frequency equal to 0 Hz, i.e. for non-moving pictures. The x-axis represents the frequency Fx in cycles per picture width (cyc/pw) in horizontal direction, while the y-axis represents the frequency Fy in cycles per picture height (cyc/ph) in vertical direction. The diagram shows frequency combinations that are wrongly filtered out as being chroma by the spatial comb filter. The colored areas appear more specifically for Fx frequencies of about −284 cyc/pw and 284 cyc/pw at Fy frequencies of about −234 cyc/ph, −78 cyc/ph, 78 cyc/ph and 234 cyc/ph. Circles indicate spatial frequencies of the color sub carrier. The hatched areas indicate spatial frequencies that are wrongly interpreted as being chroma. The latter phenomenon is also called cross color. It can be seen that the each of the colored areas comprises a circle and connected hatched portions in vertical direction, each hatched portion having about the same size.

Alternatively to a spatial comb filter, a temporal comb filter like a field comb filter can be employed for separating the chrominance signal from a composite video baseband signal. A field comb filter for PAL for separating a chrominance signal from a composite video baseband signal is equally described in the above cited document “Video Signalverarbeitung”. This field comb filter filters in vertical direction with a delay of 312 lines and in addition in temporal direction. The filtering is performed over two lines and two fields.

FIG. 2 is a diagram depicting the chroma bandpass area of such a field comb filter in the Fx/Fy plane for non-moving pictures. The structure of the diagram corresponds to the structure of the diagram of FIG. 1, and colored areas appear at the same frequency combinations. It can be seen, however, that on the one hand the field comb filter performs clearly better than the spatial comb filter in the neighborhood of −78 cyc/ph, since the corresponding colored areas comprise only circles and no hatched portions in vertical direction. On the other hand, the hatched portions of the colored areas in the neighborhood of ±234 cyc/ph are larger in vertical direction than with the spatial comb filter, and the field comb filter reduces the resolution in these frequency areas.

The above cited document “Video Signalverarbeitung” further mentions a frame comb filter as another type of temporal comb filter. A frame comb filter for PAL, which performs a filtering over two lines and four fields, allows a complete removal of cross color for non-moving pictures. This kind of filter has the disadvantage, however, that it requires a large memory and it is thus rather expensive.

The filtering employed for separating a chrominance signal from a composite video baseband signal is advantageously used in an adaptive way depending on the amount of motion detected between different fields. In an adaptive filtering, a different lind of filtering is used in case of a detected motion than in case of a non-moving picture. For an adaptive filtering, the frame comb filter for PAL has the additional disadvantage that the motion would be detected only between a first field and a field delayed by four fields. As a result, changes between consecutive fields are not detected, as in the case of a field comb filter.

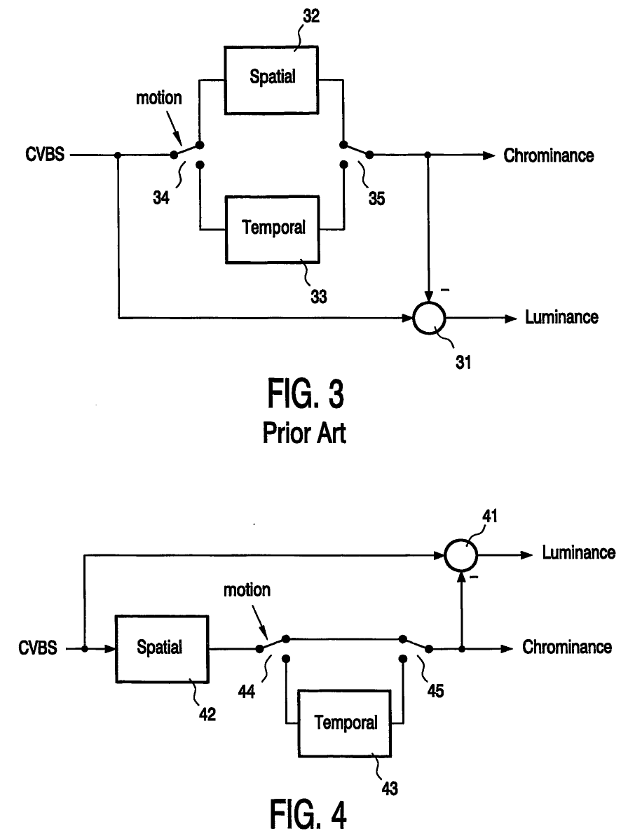

Document U.S. Pat. No. 5,502,509 describes a separator which employs a spatial comb filter and a temporal comb filter in parallel, in order to take account of motion in a picture. A 2D adaptive filter is used as spatial comb filter and a frame comb filter as temporal filter. The principle of this approach is depicted in FIG. 3.

FIG. 3 is a block diagram which comprises a summing point 31, a spatial filter 32, a temporal filter 33. A received composite video baseband signal CVBS is fed to the summing point 31 and in addition via a first switch 34 either to the spatial filter 32 or to the temporal filter 33, depending on a detected motion in a picture. The output of the respective filter 32, 33 to which the CVBS is fed is output via a second switch 35 as chrominance signal. The provided chrominance signal is subtracted in addition at the summing point 31 from the original CVBS, in order to obtain as well the luminance signal in the CVBS. The filtering does not have to be carried out exclusively by the spatial filter 32 or exclusively by the temporal filter 33. Document U.S. Pat. No. 5,502,509 proposes for example to provide the CVBS to both filters 32, 33 at the same time and to mix the output signals with a ratio depending on the detected amount of motion in the picture.

While this approach adjusts the filtering to different amounts of motion in a picture, it is not able to minimize the cross coloring for all vertical frequencies for a given amount of motion in a picture, for example for a non-moving picture. Thus, the input signal is incorrectly decoded for some spatial frequencies, typically for a vertical frequency of ±234 cyc/ph.

It is an object of the invention to enable an improved, simple separation of a chrominance signal from a composite video baseband signal. It is in particular an object of the invention to reduce the cross coloring for a non-moving picture.

These objects are reached according to the invention with a method which comprises filtering a composite video baseband signal sequentially by means of spatial comb filter means in horizontal and vertical direction and by means of field comb filter means in vertical direction and temporally, in order to separate a chrominance signal from the composite video baseband signal. The objects are equally reached with a chrominance-luminance separator comprising spatial comb filter means and field comb filter means realizing the proposed method. The order of application of the spatial comb filter means and the field comb filter means on the composite video baseband signal is not fixed.

The invention proceeds from the consideration that it is desirable to combine the advantages of a spatial comb filtering for certain vertical frequencies with the advantages of a field comb filtering for other vertical frequencies. This can be achieved by the proposed sequential spatial and temporal comb filtering of a received composite video baseband signal.

It is an advantage of the invention that it reduces the amount of incorrectly decoded signals, i.e. the amount of signals that are interpreted as chrominance signals even though they constitute luminance signals.

Preferred embodiments of the invention become apparent from the dependent claims.

The invention can be used in particular, though not exclusively, to supplement any field comb filters employed for PAL and NTSC. The invention can further be employed in particular, though not exclusively, in any application in which a composite video baseband signal must be processed in order to obtain YUV (luminance/chrominance) or RGB (red, green, blue) signals, for example in TV sets, in DVD players, in PC-TV cards etc.

The invention will now be described in more detail by way of example and with reference to the attached drawings, wherein:

FIG. 1 is a diagram showing a chroma bandpass area of a spatial comb filter in the Fx/Fy plane;

FIG. 2 is a diagram showing a chroma bandpass area of a field comb filter in the Fx/Fy plane;

FIG. 3 is a block diagram illustrating schematically a known chrominance-luminance separator;

FIG. 4 is a block diagram illustrating schematically an embodiment of a chrominance-luminance separator according to the invention;

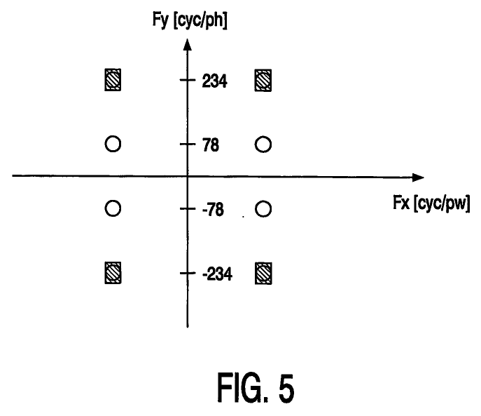

FIG. 5 is a diagram showing a chroma bandpass area of a combined spatial and field comb filter in the Fx/Fy plane;

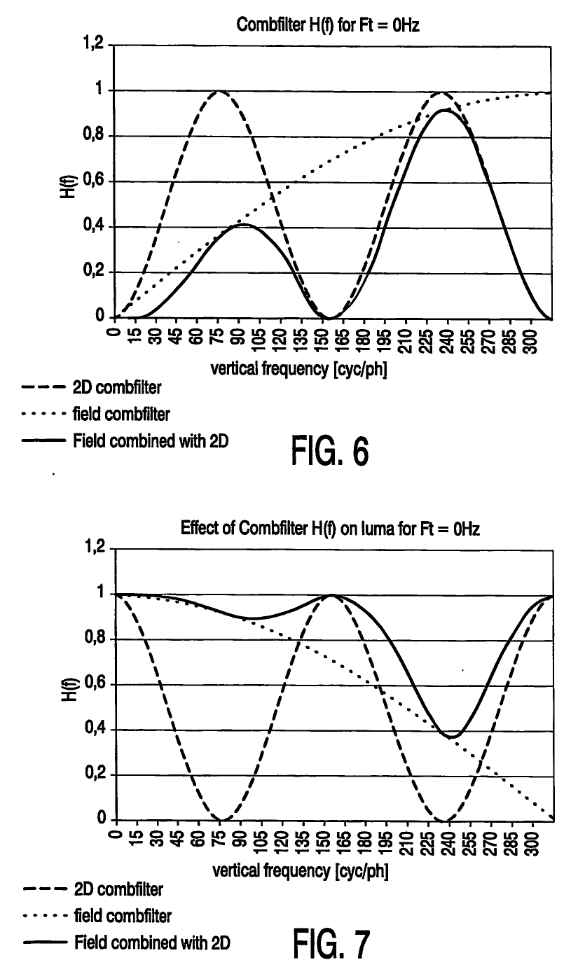

FIG. 6 is a diagram illustrating the effect of a 2D spatial comb filter, of a field comb filter and of a combined filter on the chrominance signal;

FIG. 7 is a diagram illustrating the effect of a 2D spatial comb filter, of a field comb filter and of a combined filter on the luminance signal;

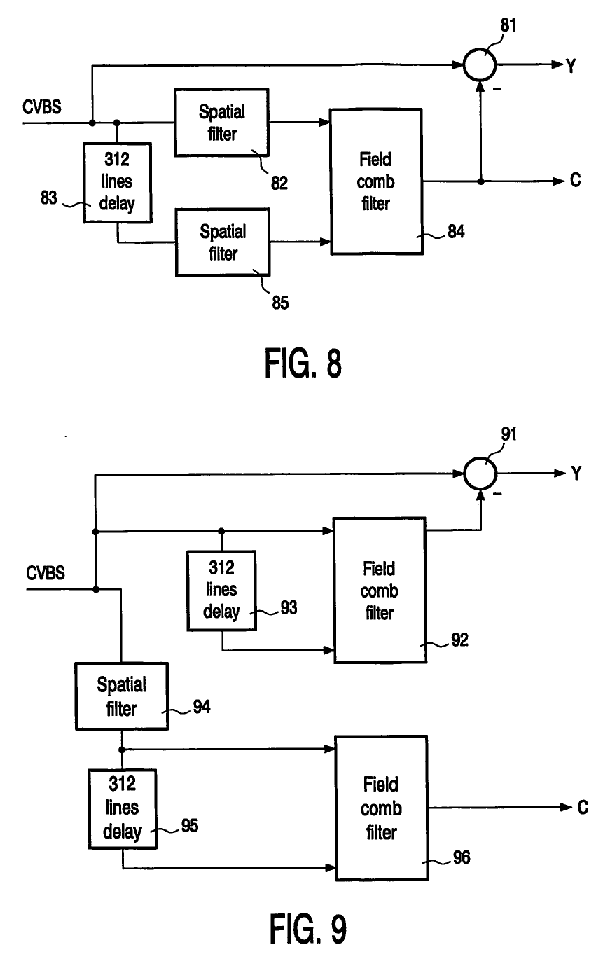

FIG. 8 is a block diagram illustrating schematically a first more detailed embodiment of a chrominance-luminance separator according to the invention;

FIG. 9 is a block diagram illustrating schematically a second more detailed embodiment of a chrominance-luminance separator according to the invention;

FIGS. 1 to 3 have already been described above.

FIG. 4 is a block diagram which illustrates the principle of an embodiment of a chrominance-luminance separator according to the invention.

An input of the separator, to which a composite video baseband signal CVBS is fed, is connected on the one hand to a summing point 41 and on the other hand to the input of a spatial filter 42. The output of the spatial filter 42 is fixedly connected to a switch 44, which can be connected in addition either to the input of a temporal filter 43 or to a second switch 45. The second switch 45 is connected fixedly to the summing point 41 and an output of the separator for a chrominance signal, and can be connected in addition either to the first switch 44 or to the output of the temporal filter 43. The output of the summing point 41 is connected to an output of the separator for a luminance signal. The temporal filter 43 can be for example a frame comb filter applying only a temporal filtering or a field comb filter applying a temporal and a vertical filtering. Moreover, a motion detection circuit is provided, which is not shown in the figure. An output of the motion detection circuit is connected to a respective control input of both switches 44, 45.

A CVBS which is provided to the separator is forwarded to the summing point 41 and to the spatial filter 42. The spatial filter 42 filters the signal spatially.

In case basically no motion is detected in the current picture by the motion detection circuit, both switches 44, 45 are connected to the temporal filter 43. The spatially filtered signal is thus provided via switch 44 to the temporal filter 43, where it is filtered in addition at least temporally. The spatially and temporally filtered CVBS is then provided via switch 45 as chrominance signal to the corresponding output of the separator. The spatially and temporally filtered CVBS is moreover provided via switch 45 to the summing point 41, where it is subtracted from the original CVBS, the difference being provided as luminance signal at the corresponding output of the separator.

In case a significant motion is detected in the current picture by the motion detection circuit, the two switches 44, 45 are connected to each other instead. The spatially filtered signal is thus provided via switches 44 and 45 immediately as chrominance signal at the corresponding output of the separator. Further, the spatially filtered CVBS is forwarded via switches 44 and 45 immediately to the summing point 41 and subtracted from the original CVBS, the difference being provided as luminance signal at the corresponding output of the separator.

FIG. 5 is a diagram depicting the resulting chroma bandpass area in the Fx/Fy plane for non-moving PAL pictures when a field comb filter is combined with a 2D spatial comb filter. The x-axis represents the frequency Fx in cycles per width (cyc/pw) in horizontal direction, while the y-axis represents the frequency Fy in cycles per height (cyc/ph) in vertical direction. The diagram shows frequency combinations that are filtered out as being chroma by the combined filter. The colored areas appear at Fy frequencies of −234 cyc/ph, −78 cyc/ph, 78 cyc/ph and 234 cyc/ph. Circles indicate the spatial frequencies of the chroma sub carrier, while hatched areas indicate spatial frequencies that are wrongly interpreted as being chroma. The structure of the diagram thus corresponds to the structure of the diagrams in FIGS. 1 and 2. It can be seen that a sequential application of a 2D spatial filter and a field comb filter combines the advantages of the spatial comb filter and the field comb filter indicated in FIGS. 1 and 2. More specifically, the color areas at ±78 cyc/ph do not comprise any hatched portions in vertical direction, as achieved with a pure field comb filtering, while at the same time the color areas at ±234 cyc/ph comprise only small hatched portions in vertical direction, as achieved with a pure spatial filtering.

FIGS. 6 and 7 further illustrate the effect of a sequential filtering with a spatial filter and a field comb filter for PAL. The effect on the chrominance signal is shown in FIG. 6, while the effect on the luminance signal is shown in FIG. 7.

FIG. 6 is a diagram which depicts three different chroma pass bands H(f) for vertical frequencies f between 0 cyc/ph and about 310 cyc/ph at a temporal frequency equal to zero and a horizontal frequency in the neighborhood of 283.75 cyc/pw. This corresponds to the chroma pass band in vertical direction for a non-moving PAL zoneplate at a horizontal frequency of Fx=283.75 cyc/pw.

The ideal curve of the chroma pass band H(f) would be a straight horizontal line on the X-axe, i.e. H(f)=0. The worst possible result would be a straight horizontal line with H(F)=1 and could be achieved for example with a horizontal band pass and notch filter combination.

The first depicted curve 61 of a chroma pass band H(f), which is drawn with a dashed line, is a curve resulting with a 2D spatial comb filter only, and thus corresponds to FIG. 1. The curve 61 has two maxima, the first at a vertical frequency of 78 cyc/ph, and the second at a vertical frequency of 234 cyc/ph. These frequencies are exactly the vertical frequencies where the colored circles in the PAL zoneplate are situated when the zoneplate is filtered with a 2D spatial comb filter.

The second depicted curve 62 of the chroma pass band H(f), which is drawn with a dotted line, is a curve resulting with a field comb filter only, and thus corresponds to FIG. 2. The curve 62 is high pass shaped. The field comb filter clearly results in a performance improvement at a vertical frequency of 78 cyc/ph. The improvement is about 8.4 dB with respect to the 2D spatial comb filter and the band pass and notch filter combination. At a vertical frequency of 234 cyc/ph, there is a small improvement of 0.7 dB. The field comb filter also has its disadvantages, though. At every frequency where the field comb filter curve 62 is above the 2D spatial comb filter curve 61, the field comb filter will result in larger cross color areas than the 2D spatial comb filter. For example, at a vertical frequency of 156 cyc/ph, the field comb filter is far worse in performance compared with the 2D spatial comb filter. At this vertical frequency of 156 cyc/ph, the field comb filter is in fact only 3dB better than the band pass and notch filter combination. Thus, the advantage of the field comb filter at a vertical frequency of 78 cyc/ph is partly canceled out by the worse performance at a vertical frequency of 156 cyc/ph.

The third depicted curve 63 of the chroma pass band H(f), which is drawn with a solid line, is a curve resulting when a 2D spatial comb filter is followed by a field comb filter, and thus corresponds to FIG. 5. When a 2D spatial comb filter precedes the field comb filter, a combination of the two curves 61 and 62 can be obtained. As can be seen in FIG. 6, the performance of the combined filter is always better or equal to the performance of the individual filters, as far as cross color is concerned.

FIG. 7 is a diagram which depicts three different luminance pass bands H(f) for PAL for vertical frequencies f between 0 cyc/ph and about 310 cyc/ph at a temporal frequency equal to zero and a horizontal frequency in the neighborhood of 283.75 cyc/pw.

The ideal curve of the luminance pass band H(f) would be a straight horizontal line at H(f)=1. The luminance curve for a band pass and notch filter combination would be a straight line at H(f)=0, which is certainly unwanted.

The first depicted curve 71 of the luminance pass band H(f), which is drawn with a dashed line, is a curve resulting with a 2D spatial comb filter only. The second depicted curve 72 of the luminance pass band H(f), which is drawn with a dotted line, is a curve resulting with a field comb filter only. The third depicted curve 73 of the luminance pass band H(f), which is drawn with a solid line, is a curve resulting with a combination of a 2D spatial comb filter and a field comb filter.

As can be seen in FIG. 7, the 2D spatial comb filter loses all resolution at a vertical frequency of 78 cyc/ph, while the field comb filter only loses 0.7 dB compared to the ideal curve. At a vertical frequency of 158 cyc/ph, however, the field comb filter loses 3 dB compared to the 2D spatial comb filter. At a vertical frequency of 234 cyc/ph, the 2D spatial comb filter shows no resolution at all, while the field comb filter loses about 8 dB compared to the ideal curve. Also in the luminance path, the combination of a 2D spatial comb filter with a field comb filter shows the best overall results.

FIG. 8 is a block diagram illustrating a first more detailed embodiment of the separator according to the invention.

The separator of FIG. 8 comprises an input for a CVBS, which is connected to a first input of a summing point 81, to an input of a first 2D spatial comb filter 82 and to an input of a 312 lines delay 83. The output of the first 2D spatial comb filter 82 is connected to a first input of a field comb filter 84. The output of the 312 lines delay 83 is connected via a second 2D spatial comb filter 85 to a second input of the field comb filter 84. The output of the field comb filter 84 is connected on the one hand to an output of the separator for a chrominance signal C and on the other hand to a second input of the summing point 81. The output of the summing point 81 is connected to an output of the separator for a luminance signal Y. The 2D spatial comb filters 82, 85 and the field comb filter 82 per se are known from the state of the art.

A CVBS input to the separator is on the one hand immediately filtered spatially by the first 2D spatial comb filter 82, and on the other hand first delayed by the 312 lines delay 83 and then filtered spatially by the second 2D spatial comb filter 85. The spatially filtered signals are then field combed by the field comb filter 84. More specifically, in the field comb filter 84, the delayed and spatially filtered signal is subtracted from the only spatially filtered signal, resulting in a vertically and temporally filtered signal. By the preceding spatial filtering, the vertical working area of the field comb filter is restricted to the same area as the one of the 2D spatial comb filter.

The field combed signal is output by the separator as chrominance signal C. Moreover, field combed signal is subtracted at the summing point 81 from the original CVBS in order to obtain the luminance signal Y, which is equally output by the separator.

In an alternative to the structure of FIG. 8, the CVBS input of the separator could be connected only to the summing point and to a single 2D spatial comb filter, while the output of this single 2D spatial comb filter is connected on the one hand directly and on the other hand via a 312 lines delay to the inputs of the field comb filter. This would reduce the number of required filters.

It is further to be noted that the circuit of FIG. 8 may be combined with switches and a motion detector as described with reference to FIG. 4, in order to be able to bypass the field comb filter, when a motion is detected in the picture.

In addition, non-linear filter actions like median filtering and so called ‘signal line’ solutions can be implemented in the proposed separator, in order to take care of cross luminance problems of the 2D spatial comb filters at colored vertical transients.

The field comb filter should be selected such that it can compensate certain imperfections in the output signal of the 2D spatial comb filter, e.g. cross luminance artefacts resulting in so called ‘hanging dots’. Moreover, the 2D spatial comb filters should be selected such that they do not output half saturated lines on colored single lines, since this reduction in saturation remains in the output signal and cannot be undone by a field comb filter. In the whole, in order to obtain an optimal result the employed 2D spatial comb filters and the employed field comb filter should be well matched to each other, taking into account as well the amplitude charts as the phase charts of the filters so that any unwanted luminance components in the chrominance signal output by the 2D spatial comb filter are removed by the field comb filter.

If the resulting clean chrominance signal is subtracted from the CVBS signal to obtain a clean luminance signal, as in FIG. 8, the luminance signal may show cross luminance problems at vertical colored transients. Therefore, it is proposed that the combination of the 2D spatial comb filter or filters and the field comb filter is only used for obtaining the chrominance signal, but not for obtaining the luminance signal.

A block diagram illustrating a corresponding embodiment of the separator according to the invention is depicted in FIG. 9.

The separator of FIG. 9 comprises an input for a CVBS, which is connected to an input of a summing point 91, to a first input of a first field comb filter 92 and to an input of a first 312 lines delay 93. The output of the first 312 lines delay 93 is connected to a second input of the first field comb filter 92, and the output of the first field comb filter 92 is connected to a second input of the summing point 91. The output of the summing point is connected to an output of the separator for a luminance signal Y. The input of the separator for a CVBS is equally connected to an input of a 2D spatial comb filter 94. The output of the 2D spatial comb filter 94 is connected on the one hand directly and on the other hand via a second 312 lines delay 95 to the inputs of a second field comb filter 96. The output of the second field comb filter 96 is connected to an output of the separator for a chrominance signal C.

The part of the separator comprising components 91-93 is provided exclusively for separating a luminance signal from a CVBS, while the part of the separator comprising components 94-96 is provided exclusively for separating a chrominance signal from a CVBS.

The chrominance signal is obtained similarly as in FIG. 8. The CVBS is first filtered by the 2D spatial comb filter 94. The spatially filtered signal is then provided on the one hand directly to the second field comb filter 96. On the other hand, it is first delayed by the 312 lines delay 95 before it is fed to the second field comb filter 96. The 2D filtered signals are then field combed by the field comb filter 96 as described with reference to FIG. 8, in order to obtain the chrominance signal C. As in FIG. 8, the vertical working area of the field comb filter is thereby restricted to the same area as the one of the 2D spatial comb filter.

For obtaining the luminance signal, a separate field comb filter 92 is provided. The CVBS is forwarded on the one hand directly to the field comb filter 92 and on the other hand after a delay by the 312 lines delay 93. The CVBS signals are then field combed by the field comb filter 92, i.e. the delayed signal is subtracted from the original CVBS signal by the field comb filter 92, resulting in a vertically and temporally filtered signal. The resulting signal is subtracted from the original CVBS at summing point 91, in order to obtain the luminance signal Y. The loss in resolution at e.g. 156 cyc/ph, which is indicated in FIG. 7, can be compensated after the field comb filtering by using a peaking filter with a suitable curve. Such a curve can be calculated, since the field comb filter characteristic is known.

It is to be noted that the described embodiments of the invention constitute only some of a variety of possible embodiments. It is further understood that any of the presented embodiments of the invention can be varied and supplemented in many ways.

1. A method for separating a chrominance signal from a composite video baseband signal, said method comprising filtering said composite video baseband signal sequentially in any order by means of spatial comb filter means in horizontal and vertical direction and by means of field comb filter means in vertical direction and temporally to obtain said chrominance signal.

2. The method according to claim 1, wherein said composite video baseband signal is first filtered by means of at least one spatial comb filter, and wherein said spatially filtered signal is then filtered by means of a field comb filter.

3. The method according to claim 1, comprising comb filtering said composite video baseband signal spatially to obtain a first signal, delaying said composite video baseband signal and comb filtering said delayed signal spatially to obtain a second signal, and field comb filtering said first and said second signal to obtain said chrominance signal.

4. The method according to claim 1, comprising comb filtering said composite video baseband signal spatially to obtain a first signal, delaying said first signal to obtain a second signal, and field comb filtering said first and said second signal to obtain said chrominance signal.

5. The method according to claim 1, further comprising detecting a presence of motion between pictures represented by said composite video baseband signal and bypassing said field comb filtering in case of a detected motion between said pictures.

6. The method according to claim 1, further comprising separating a luminance signal from said composite video baseband signal by subtracting said obtained chrominance signal from said composite video baseband signal.

7. The method according to claim 1, further comprising separating a luminance signal from said composite video baseband signal by field comb filtering said composite video baseband signal and by subtracting said field comb filtered signal from said composite video baseband signal.

8. The method according to claim 7, further comprising applying a peak filtering to a luminance signal resulting from said subtraction.

9. A chrominance-luminance separator for separating a chrominance signal from a composite video baseband signal, said separator comprising spatial comb filter means for filtering a signal in vertical direction and in horizontal direction and field comb filter means for filtering a signal in vertical direction and temporally, wherein a composite video baseband signal received by said chrominance-luminance separator is processed by said spatial comb filter means and said field comb filter means sequentially in any order.

10. An image processing apparatus comprising the chrominance-luminance separator as claimed in claim 9.

11. An image processing apparatus as claimed in claim 10, characterized in that it is a TV.
